(19) United States
(12) Patent Application Publication
(10) Pub. No.: US 2024/0120718 A1
(43) Pub. Date: Apr. 11, 2024

(54) METHOD AND WIRE PROCESSING MACHINE THAT PRODUCES SHAPED PARTS FROM INSULATED FLAT MATERIAL

(71) Applicant: WAFIOS Aktiengesellschaft, Reutlingen (DE)

(72) Inventors: Robin Sautter, Pfullingen (DE); Tobias Single, Dettingen (DE)

(21) Appl. No.: 18/264,905

(22) PCT Filed: Jan. 17, 2022
(86) PCT No.: PCT/EP2022/050894

§ 371 Date: Aug. 9, 2023

(30) Foreign Application Priority Data
Feb. 10, 2021 (DE) 10 2021 201 275.2

(51) Int. Cl. H02G 1/12; B21F 1/00; H02G 1/00

(52) U.S. Cl. CPC H02G 1/126; B21F 1/00; H02G 1/005

(57) ABSTRACT

A method of producing shaped parts includes drawing insulated flat material with a draw-in device and processing in a wire processing machine to form the shaped part material; separating the shaped part from supplied insulated flat material by cutting, wherein before the shaped part is separated, part of the insulation layer is removed in a portion of the flat material; and synchronously with feeding stripping tools on each side of the flat material, feeding at least one supporting element toward the flat material.

### TECHNICAL FIELD

This disclosure relates to a method of producing straight or bent shaped parts from insulated flat material, and a wire processing machine suitable for carrying out the method having a stripping device for stripping portions of the insulated flat material.

### BACKGROUND

Vehicles with fully or partially electric drives are increasingly being offered on the market. Most of such vehicles have high-capacity energy storage systems with a plurality of battery modules. The electrical energy must be transported between the individual battery modules. To that end, insulated and bent copper or aluminum bars, which are also referred to as “busbars,” are used. Furthermore, the wiring harnesses that run in the longitudinal direction of vehicles between the front and the rear are increasingly being replaced by busbars. Owing to the ever increasing currents, busbars with a correspondingly large current-carrying cross-section are required. Because the spaces available for the installation of busbars are sometimes relatively cramped and geometrically complex, busbars that have bends in one or more locations are many times required.

Flat materials in the form of insulated and bent copper or aluminum wires with a rectangular cross-section are frequently also used in the production of coil elements for electric motors.

In the production of insulated flat material for a busbar or a coil element, an electrically conducting carrier material (e.g., a flat wire of aluminum or copper) is first coated or sheathed from end to end with an electrically insulating insulation layer. However, the insulation layer is to be removed at the contact points with the electrical connector of the element so that the carrier material is as bare as possible. A working step of “stripping” is carried out for this purpose. Stripping is a process in which part of the insulating sleeve (also “insulation” or “insulation layer”) of an electrical conductor is removed over a specific length required for connection (“stripping length”). For subsequent fastening in the installation environment in question, busbars are then generally either screwed down, clamped or soldered. Coil elements are fastened in a corresponding manner.

U.S. Pat. No. 7,480,987 B1 describes a method and an apparatus for receiving insulated flat material having a rectangular cross-section from a spool, straightening it, stripping it over a predetermined length, then feeding it to a bender, cutting it to length and then bending it. The material is first guided through a straightener. The straightened material then enters the region of a stripper before being fed, after the stripping operation, to a feeder which has a fixed wire grabber and a movable wire grabber. The stripped wire is then cut to length. The cut pieces of wire are then fed to the bender. On each side of the passage axis of the flat material, the stripper has a diamond-coated wheel that can be driven by way of its own drive and is carried by a pneumatically adjustable pivot arm. The diamond wheels are arranged axially offset relative to one another. For each diamond-coated wheel there is an opposite backup roller able to absorb the processing forces of the opposite diamond-coated wheel. By pivoting of the pivot arms, the diamond wheels can be brought into working engagement with the insulating layer and can strip the flat material on opposite sides. To that end, the stripper as a whole is moved back and forth along guide rails while the diamond-impregnated wheels rotate.

There is nonetheless a need to provide a method and a wire processing machine that can be used with high productivity inter alia in the manufacture of partially stripped busbars, coil elements or precursors thereof such that the stripped portions of the carrier material provided for contacting, for example, are to have a surface that is as undamaged and as clean as possible.

### SUMMARY

We provide a method of producing straight or bent shaped parts from insulated flat material having an electrically conducting carrier material sheathed by an electrically insulating insulation layer, comprising: 1) drawing the insulated flat material from a material supply by a draw-in device and processing in the wire processing machine to form a straight or bent shaped part of insulated flat material; 2) separating the shaped part from the supplied insulated flat material in a cutting operation, wherein before the shaped part is separated from the supplied flat material, part of the insulation layer is removed from the electrically conducting carrier material in at least a portion of the insulated flat material in a stripping operation, stripping tools on opposite side faces of the flat material are fed in the direction toward the side faces to a working position in which the stripping tools are in engagement with the insulation layer, and the stripping tools and the flat material are moved relative to one another parallel to a passage axis; and 3) synchronously with the feeding of the stripping tools on each side of the flat material, feeding at least one supporting element of a supporting device in the direction toward the flat material and bearing with a supporting face against the flat material in an immediate vicinity of an engagement position of the stripping tool when the stripping tool is in a working position.

We also provide a wire processing machine that produces straight or bent shaped parts from insulated flat material, comprising: a draw-in device that draws the flat material from a material supply and conveys the flat material parallel to a passage axis; an alignment device that aligns the flat material; a cutting device that separates the shaped part from the supplied insulated flat material; an integrated stripping device that strips portions of the insulated flat material before the shaped part is separated from the supplied flat material, wherein the stripping device has on opposite sides of a passage axis at least one stripping tool that can be fed by a feed axis of the wire processing machine from a neutral position into a working position in which it is in engagement in a material-removing manner with the insulation material, on each side of the passage axis there is arranged at least one supporting element of a supporting device, which supporting element can be fed in the direction toward the flat material by the feed axis synchronously with feeding of an associated stripping tool and is configured to bear with a supporting face against the flat material in an immediate vicinity of the engagement position of the stripping tool when the stripping tool is in the working position.

### BRIEF DESCRIPTION OF THE DRAWINGS

Further advantages will become apparent from the following description of preferred examples that will be explained hereinbelow with reference to the figures.

FIG. 1 shows a schematic side view of a wire processing machine according to an example having a stripping tool which works with milling cutters.

FIG. 2 shows an oblique perspective view of the stripping device configured as a milling device, with associated components.

FIG. 3 shows details of supporting elements of a supporting device in the region of a clamping device associated with the milling device.

FIGS. 4A to 4C show different phases of a stripping operation.

FIG. 5 shows, schematically, components of an example having two fixed steps for each stripping tool.

FIG. 6 shows, schematically, components of an example in which only one supporting element is associated with each stripping tool.

FIG. 7 shows, schematically, components of an example having two spring-mounted stops for each stripping tool.

FIG. 8 shows, schematically, components of an example in which the flat material, for the stripping operation, is advanced relative to a milling unit that is positioned so that it is fixed relative to the machine.

FIG. 9 shows an example of a wire processing machine which is configured in the manner of a rod manufacturing machine with an integrated stripping device.

### DETAILED DESCRIPTION

Our methods and wire processing machines are suitable for the production of straight or bent shaped parts from insulated flat material having an electrically conducting carrier mater-ial sheathed by an electrically insulating insulation layer. The insulated flat material is drawn from a material supply by a draw-in device and is processed in the wire processing machine to form a straight or bent shaped part of (at least partly) insulated flat material. The shaped part is then separated from the supplied insulated flat material in a cutting operation. Before the shaped part is separated from the supplied flat material, part of the insulation layer is removed from the electrically conducting carrier material in at least a portion of the insulated flat material in a stripping operation by a stripping device integrated in the wire processing machine. To that end, stripping tools of the stripping device on opposite side faces of the flat material are fed in a feed movement in the direction toward the associated side faces to a working position in which they are in engagement with the insulation layer, and the stripping tools in engagement with the insulation layer and the flat material are moved relative to one another parallel to a passage axis.

The relative movement can be achieved, for example, in that the flat material is stationary, or is not moved, during the stripping operation, while the stripping tools in engagement with the flat material are moved parallel to the passage axis. It is also possible that the stripping tools remain in the working position, while the flat material is moved relative to the stationary stripping tools. It is also possible that both the stripping tools and the flat material are moved for the stripping operation, but at different speeds and/or in different phases.

The term “flat material” generally denotes workpieces, the carrier material of which has at least one pair of side faces oriented parallel to one another. The carrier material can have, for example, a rectangular cross-section with equal side widths (square cross-section) or with unequal side widths as well as with relatively sharp or slightly or fully rounded edges and/or edges provided with a chamfer.

The term “passage axis” denotes an axis defined by the machine and along which the flat material is advanced in advancing phases, for example, in the direction toward shaping tools and/or a cutting device. A longitudinal center axis of the flat material should be as coaxial with the passage axis as possible.

Feeding in the direction of the flat material is effected by a feed axis of the wire processing machine. The term “feed axis” denotes a numerically controlled machine axis of the wire processing machine, which effects the feeding of one or more stripping tools from a neutral position, in which they are not in engagement with the insulation layer, to a working position, in which they are in engagement with the insulation layer. The opposite movement is also controlled by the feed axis. The feed direction, that is to say the direction of the feed movement, preferably runs perpendicular to the passage axis but may also run obliquely thereto so that only one component of the feed movement runs perpendicular to the passage axis.

The method is characterized in that, synchronously, or simultaneously, with the feed movement of the stripping tools on each side of the flat material, at least one supporting element of a supporting device is fed in the direction toward the flat material and bears with a supporting face against the flat material in the immediate vicinity of the engagement position of the stripping tool when the associated stripping tool is in the working position.

At the wire processing machine, the ability to carry out the method is achieved in that there is arranged on each side of the flat material, or of the passage axis, at least one supporting element of a supporting device, which supporting element is coupled with a stripping tool and can be fed in the direction toward the flat material by the feed axis, which is also responsible for the feeding of the stripping tool, and configured to bear with a supporting face against the flat material in the immediate vicinity of the engagement position of the stripping tool when the stripping tool is in the working position.

Bearing “in the immediate vicinity” of the engagement position means, inter alia, that no further element contacts the flat material between the support point, at which the supporting element is in contact with the flat material, and the engagement position, at which the stripping tool is in engagement with the insulation layer. A supporting element can bear against the flat material immediately in front of or immediately behind the engagement position, wherein the terms “in front of” and “behind” refer to the longitudinal direction of the flat material, or the direction of the passage axis.

Our novel approach addresses, inter alia, the following problems. In a flat material guided within a wire processing machine and is to be stripped in the region of the stripping device, the flat material is usually not guided between a last clamping point before the region of the stripping device and a clamping point after the stripping device so that there is a certain free length of the flat material. This is where the stripping tools engage. Depending on the nature of the flat material, the flat material can be more or less unstable and sensitive to transverse forces in this region of the free length. When the stripping tools are fed on both sides, it may be in practice that they do not come into engagement with the flat material at exactly the same time so that it may be that the insulation layer is thus removed asymmetrically. This can have the result that the insulation layer can be removed on one of the sides, while there are still insulation layer residues on the opposite side. To avoid such incomplete stripping, the end position of the feed close to the material could be displaced in the direction toward the flat material to ensure that the insulation layer is always removed completely on both sides. However, this would result in a greater volume of waste, the carrier material would additionally have a smaller cross-section, and greater wear of the stripping tools could occur because, at least on one side, they also engage into the carrier material, which is harder compared to the insulation layer.

A further problem is possible lifting of the flat material in the region in which it is stretched freely. Such lifting can lead to chatter marks on the surface of the stripped carrier material.

In some kinds of stripping tools, the flat material can be loaded unequally in the transverse direction on engagement of a stripping tool and can thus be twisted slightly, which can lead to poorer results on stripping.

When our methods and machines are used, these problems can be addressed to such an extent that the practical effects are tolerable. The flat material is mechanically contacted in the vicinity of the engagement position by the supporting elements, which are fed together with the stripping tools, and is thus guided and stabilized so that, by virtue of the supporting elements contacting the flat material, the engagement situation of the stripping tool is defined more precisely than in the absence of support close to the engagement point. In addition, (one or more) supporting elements in contact close to an engagement point can help to ensure that the stripping tools do not penetrate the insulation material too deeply or too shallowly. Furthermore, we found that vibrations of the flat material in the region of the engagement position can be largely suppressed, or at least reduced to such an extent that measurably better surfaces of the carrier material are obtained, by the (one or more) supporting elements that are in contact in the vicinity. The contacting supporting elements contribute to vibration reduction or vibration damping in the critical engagement region between the stripping tool and the flat material. In this respect, a supporting device associated with a stripping tool can also be referred to as a vibration damping device (which is able to be fed with the stripping tool) having at least one vibration damping element (supporting element) provided for contact with the workpiece. Finally, the risk of twisting of the flat material can likewise effectively be eliminated. Thus, when our methods and machines used, stripped portions of the carrier material have a largely undamaged, clean surface, which avoids problems on further processing.

Although support on one side of the engagement position of the stripping tool may be sufficient, it is preferably provided that the supporting device associated with a stripping tool has a first and a second supporting element, wherein the first supporting element bears in front of and the second supporting element bears behind the engagement position of the stripping tool when the stripping tool is in the working position. The stripping tool thus engages the flat mater-ial in the region between two support points of the supporting elements. The position of the stripping tool with respect to the feed direction and with respect to the flat material can thus be defined particularly accurately. Moreover, support on both sides assists with vibration damping so that the machining result is not adversely affected by vibration of the flat material and/or vibrations of the flat material relative to the engaging components of the wire processing machine.

Preferably, the supporting elements are configured as rotatably mounted supporting rollers and roll on the flat material when the stripping tools and the flat material are moved relative to one another parallel to the passage axis during the stripping operation. Particularly mater-ial-friendly, gentle support is thus possible. Alternatively, supporting elements can also have non-movable supporting faces, for example, in the form skids having a smooth supporting face.

Supporting elements can have different functions. For example, at least one supporting element is fixedly coupled with the associated stripping tool on each side such that a supporting face of the supporting element is fixed or can be fixed in a specifiable position relative to the stripping tool, based on the feed direction. A supporting element can thus serve as a mechanical stop that mechanically limits the penetration depth of the stripping tool on feeding. Preferably, the stop is adjustable in that the position of the supporting element relative to the stripping tool is preferably infinitely adjustable. If the stop is adjusted to the maximum possible tolerance of the insulation layer thickness, it is substantially ensured, without complex control, that no residues of the insulation layer remain on the carrier material. A relatively simple mechanical solution is thus provided so that more complex solutions that are likewise possible for monitoring the penetration depth can be dispensed with. The more complicated possibilities include, for example, the use of a measuring system with which the penetration depth is monitored, and regulation of the advance movement of the feed axis in dependence on results or signals of the measuring system. It is thus possible that at least one of the supporting elements of one side is configured as a stop, preferably an adjustable stop, for mechanically limiting the feeding of the associated stripping tool or serves as such a stop during operation.

We provide that at least one of the supporting elements may be resiliently flexibly mounted and bears against the flat material with the build-up of a restoring force when the associated stripping tool is in the working position. For example, there can be provided a spring arrangement having one or more springs which acts between a carrier of the supporting element and the supporting element. Particularly effective vibration damping can thus be achieved. In addition, a resiliently flexibly mounted supporting element can remain in constant contact with the guided flat material even if there is a shoulder or step, for example, at the transition from an insulated portion to a portion that is no longer insulated. Resiliently flexibly mounted supporting elements, owing to their damping action and their ability to maintain contact even when passing over steps, thus contribute considerably to improving the working result.

Preferably, an adjustable stop for mechanically limiting the deflection of the supporting element is provided. The stop is preferably infinitely adjustable and limits the available spring path on feeding.

In some configurations there is a monitoring device with which (initial) touch contact between the supporting element and the workpiece and/or the pressing force with which a supporting element is pressed against the flat material is recorded by measurement, and feeding is controlled in dependence on measurement signals from the monitoring system. It can thus be achieved, inter alia, that pressing forces acting on the flat material are sufficiently strong, but not too strong, and the wire is not clamped or deformed. The monitoring device can also detect when the supporting element first touch contacts the workpiece on feeding. From this point in time onward, the pressing force increases starting from a value of zero. Monitoring can take place, for example, by a touch sensor and/or an electrical contact that closes in dependence on pressure and/or by a strain gauge or other sensors able to generate a signal that correlates with the pressing force.

Support close to the tool can in principle advantageously be used regardless of the type of stripping. Stripping can thus be carried out, for example, by milling, shaving, grinding and/or brushing. Particular advantages are obtained in stripping by milling because particularly strong vibrations of the workpiece can occur there. At the same time, stripping by milling has been found to be very advantageous so that the benefit of a support can be particularly great here.

One example is characterized in that the stripping operation comprises a milling operation carried out by a milling device. Stripping thus takes place by geometrically defined cutting edges on rotating milling tools. During the milling operation, two milling tools having peripheral cutting edges and are rotatable about axially parallel rotational axes on opposite side faces of the flat material are fed in the direction toward the side faces into a working position in which peripheral cutting edges of the milling tools are in engagement with the insulation layer. Milling tools or milling cutters in the form of peripheral milling cutters are thus used.

A characteristic of the milling operation is that two mutually opposite side faces of the flat material are simultaneously freed of the insulation layer by peripheral milling. In this operation, one of the milling tools can support the flat material against bending under the machining forces of the opposite milling tool so that the desired orientation of the flat material coaxially with the passage axis is maintained even under the machining forces. This assists with precision in stripping by milling. Feeding from both sides, in conjunction with a peripheral milling cutter, allows the insulation layer to be removed substantially without or with only slight removal of the electrically conducting carrier material. Two opposite side faces are thus simultaneously stripped, or freed of the insulation layer, over a specifiable stripping length. The rotational axes of the milling tools preferably lie in a common plane oriented orthogonally to the passage axis.

Feeding is preferably so controlled that it takes place from the two opposite sides symmetrically relative to the passage axis of the flat material in the direction toward the side faces.

This configuration can be implemented in a wire processing machine of the type in question in that the stripping device has a milling device having (at least) two axially parallel milling units arranged such that two milling tools that are rotatable about axially parallel rotational axes on opposite side faces of the flat material can be fed into a working position in which peripheral cutting edges of the milling tools are in engagement with the insulation layer, and that the milling units (and thus also the milling tools mounted thereon) and the flat material are movable relative to one another parallel to a passage axis of the flat material.

We found that many flat materials do not have a mathematically exact rectangular cross-section with sharp edges but have more or less pronounced rounded portions (radii) or chamfers at the transitions between mutually perpendicular side faces. To reliably remove the insulation layer in these edge regions too, it can be necessary to introduce the milling tools so far into the electrically conducting carrier material that the insulation layer is removed to the greatest possible extent also in the edge regions. However, such a solution is associated with a generally undesirable removal of material from the carrier material.

There problems can be avoided by the use of milling tools in the form of profile milling tools, which have a first portion with a cylindrical enveloping surface and an adjoining second portion with an axially varying enveloping diameter at least in some portions. The second portion can be profiled, for example, to produce a radius or a chamfer.

The term “profile milling tool” refers to a milling tool, the active outer contour of which is adapted to, or reproduces, the contour of the workpiece to be milled, or more specifical-ly of the carrier material of the workpiece, to a predetermined extent. Thus, in a milling operation by a profile milling tool, it is possible to reliably strip not only a more or less planar side face, but also one of the adjoining edges. As a result, with minimal or without any removal of material from the electrically conducting carrier material, stripping can reliably be ensured over the entire periphery of the flat material even in a rectangular cross-section that is not mathematically exact.

A profile milling tool can be so configured that it acts in a first portion as a peripheral milling cutter for machining a first side face and, adjacent thereto, has a narrow portion with a varying diameter into which the peripheral cutting edges extend so that, for example, a chamfer adjoining the first side face or a radius can thereby be machined by peripheral milling.

A profile tool can optionally also be so configured that it acts in the first portion as a peripheral milling cutter for machining a first side face and then, in a transitional region (sharply step-shaped or with a radius or chamfer), acts as a face milling cutter for fully machining a second side face perpendicular to the first side face. Thus, two adjoining, mutually orthogonal side faces could simultaneously be stripped with two milling tools in a joint pass. The milling tools can be arranged axially offset relative to one another for that purpose.

As already mentioned, our methods are not limited to a particular type of stripping. A stripping tool can work by different principles with mechanical material removal. A stripping tool can, for example, be configured as a grinding tool, in particular as a grinding wheel or grinding roller with an abrasive peripheral surface. The insulation material is then removed by geometrically undefined cutting edges. A stripping tool can also be a brushing tool, the bristles of which, which consist, for example, of metal or plastics material, remove the insulation material or residues thereof on rotation of the brushing tool. A stripping tool can also be configured in the manner of a plane or scraper, that is to say can work with a geometrically defined cutting edge. A stripping device having stripping tools in the form of scrapers is described in WO 2018/134115 A1. Multiple techniques can be combined, for example, milling and then brushing.

It is possible to guide or hold the flat material to be stripped during the stripping operation on both sides of a portion to be stripped, that is to say in front of and behind a milling device or other stripping device, by controllable devices of the wire processing machine, for example, by a draw-in device and an alignment device. Preferably, it is provided that, before the start of the stripping operation, the flat material is fixed in front of and behind a working region of the stripping operation by clamping elements of a separate clamping device such that it is centered relative to the passage axis. The clamping device can be regarded as an optional assembly group of the stripping device. The clamping elements can engage relatively close to the portion to be stripped. It can thus be achieved that the flat material is optionally centered better with respect to the passage axis than without the use of the separate clamping device. The supporting elements are then present in addition to the clamping elements and can bear against the flat material in an intermediate region between a clamping element and the engagement region, that is to say even closer than the clamping elements. Because the supporting elements are in a defined or specifiable spatial relationship with the associated stripping tool, their vibration-damping and material-guiding action is maintained unchanged even in the event of a relative movement between the flat material and the stripping tool.

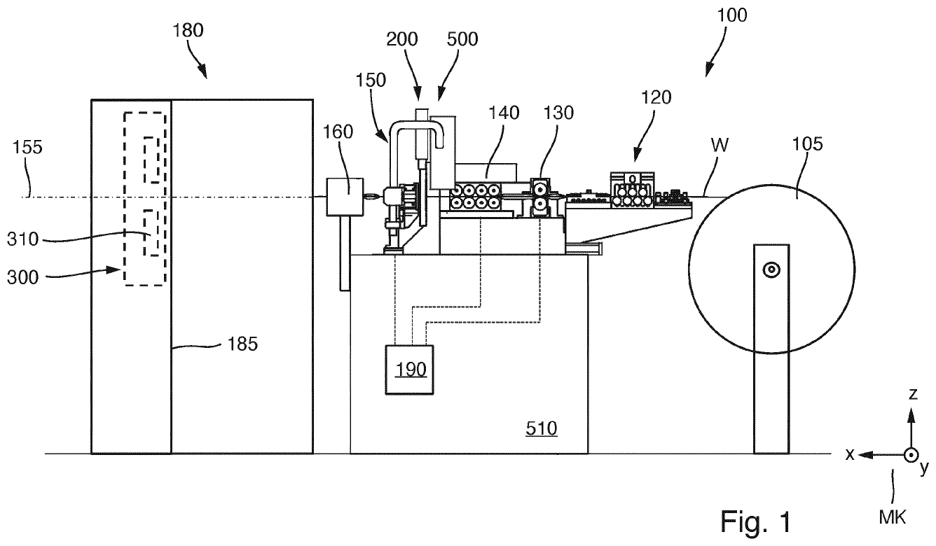

FIG. 1 shows a schematic side view of a wire processing machine 100 according to one example designed overall as a torsion spring machine. The wire processing machine has an integrated stripping device 500 for stripping portions of the insulated flat material W before the finished bent shaped part is separated from the supplied flat material. The stripping device 500 has a milling device 200.

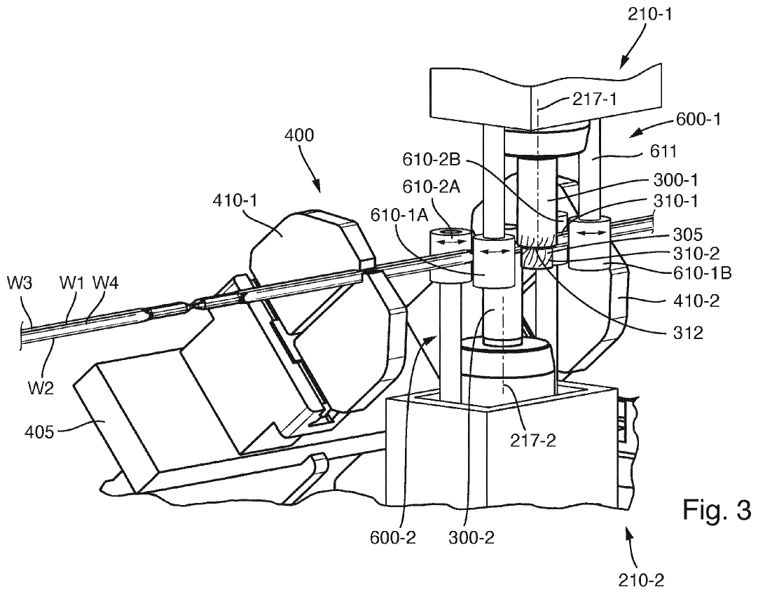

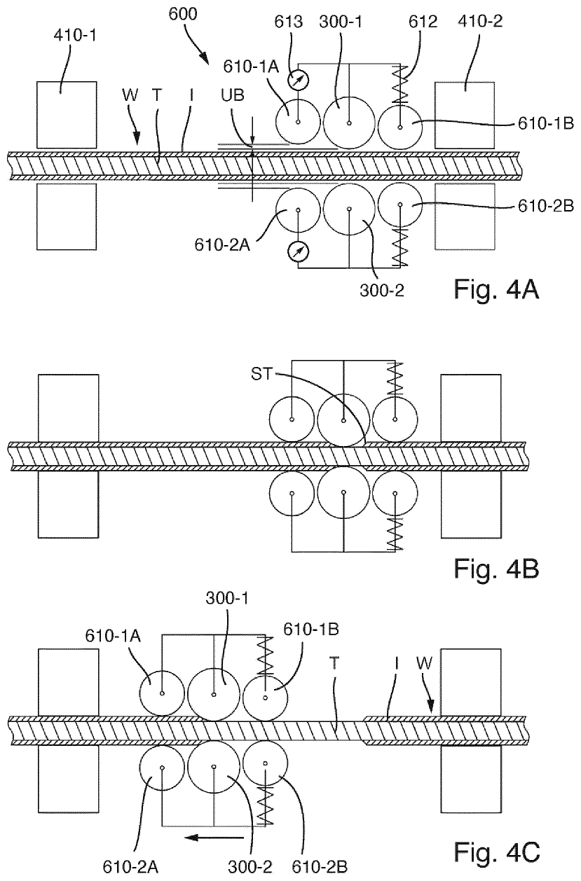

The wire processing machine 100 is adapted to produce complex bent shaped parts in the form of coil elements for electric motors. A starting material (also referred to as a workpiece W) is processed, which starting material has a wire-shaped electrically conducting carrier material T (e.g., copper) with a substantially rectangular cross-sectional shape, sheathed by an electrically non-conducting insulation layer I of lacquer, thermoplastic or the like (see e.g., FIG. 4A). The workpiece W is also referred to as “wire” or “flat material.”

The computer numerically controlled, multi-axis wire processing machine 100 has a plurality of controllable machine axes, a drive system having a plurality of electric drives for driving the machine axes, and a control device 190 for the coordinated activation of working movements of the machine axes in a manufacturing process in accordance with a computer-readable control program specific to the manufacturing process.

In the example, the wire processing machine has an orthogonal machine coordinate system MK, identified by lowercase letters x, y and z, having a vertical z-axis and horizontal x- and y-axes. The x-axis runs parallel to the passage axis 155. The machine axes, driven in a controlled manner, which are denoted by upper case letters (for example, P2-axis) on arrows are to be distinguished from the coordinate axes x, y and z. The arrows or double arrows represent the working movements which can be generated by way of the respective machine axes, or the drives thereof.

The starting material W is in the form of a wound material supply (coil), which in the example is wound on a reel 105. In other examples, a reel is not provided, the material supply can also be situated in a storage container, for example, a barrel-shaped storage container, and can be taken therefrom.

The workpiece enters the assembly group 500, also referred to as a “stripping unit” 500. This assembly group 500 comprises, in this order along the passage axis 155 of the workpiece, an alignment unit 120, a length measuring device 130, a downstream draw-in device 140, the stripping device equipped with the milling device 200, a suction device 150 associated with the milling device 200, and a brushing device 160 downstream thereof. The stripping unit 500 has its own base 510, at or on which the mentioned components are installed.

After leaving the brushing device 160, the workpiece enters a front assembly group 180 of the wire processing machine. The front assembly group 180 has a machine frame which carries on its front side a vertically oriented front wall 185. A shaping device 300 of the shaping machine, which shaping device is mounted on the front wall 185 and is accessible from the front, comprises inter alia a plurality of shaping units 310 arranged in a star shape around the passage axis and have tool heads at which one-piece shaping tools or shaping tools composed of a plurality of components can be used to shape the flat material by bending.

Behind the front wall 185 there is inter alia a further draw-in device (not shown) for drawing the elongate workpiece material from the upstream assembly group 500 and advancing, or conveying or transporting, the workpiece parallel to the passage axis 155 into the region of the shaping device 300. Upstream of the draw-in device there is an alignment unit (likewise not shown) that aligns the workpiece again before it enters the further draw-in device.

In the region of a guide device equipped with a guide sleeve, the wire emerges from the guide device, perpendicular to the front wall 185 and coaxially with the passage axis 155 of the shaping machine, into the region of the shaping device 300. The guide sleeve has a guide opening with a rectangular cross-section adapted to the rectangular cross-section of the flat material. By numerically controlled tools of the shaping device 300, the wire is shaped into a two-dimensionally or three-dimensionally bent shaped part. The finished or largely finished shaped part is then separated from the supplied wire by a cutting unit with a cutout.

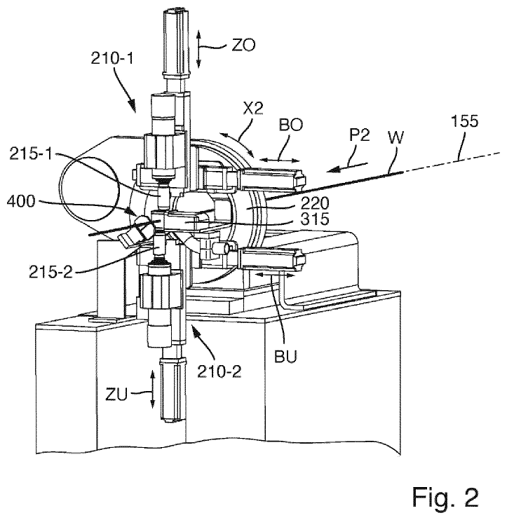

The construction and functioning of the stripping device of the example will now be explained in detail with reference to FIGS. 2 and 3. FIG. 2 shows an oblique perspective view of the milling device 200 with associated components. FIG. 3 shows details of a clamping device 400 associated with the milling device and with which the workpiece is clamped and thus fixed on both sides of the portion to be stripped for the stripping operation to be carried out. FIG. 3 further shows details of two supporting devices 600-1 and 600-2, the supporting elements of which are fed together with the stripping tools and bear against the flat material immediately next to the engagement point of the milling cutters.

The milling device 200 has two milling units (first milling unit 210-1, second milling unit 210-2), the milling spindles of which (first milling spindle 215-1, second milling spindle 215-2) are arranged axially parallel and axially offset relative to one another so that the rotational axes 217-1, 217-2 of the milling spindles are parallel and offset to one another and the milling tools (first milling tool 300-1, second milling tool 300-2) received in the milling spindles can be rotated about rotational axes which are parallel and offset relative to one another (coaxial with the rotational axes 217-1, 217-2 of the milling spindles).

The first milling unit 210-1 can be fed linearly in two directions oriented perpendicular to one another and perpendicular to the passage axis 155 by suitable machine axes. By the machine axis ZO, a linear displacement parallel to the rotational axis 217-1 of the first milling spindle 215-1 or of the first milling tool 300-1 takes place. By the machine axis BO, a linear displacement perpendicular to the rotational axis 217-1 of the milling tool takes place.

In the second milling unit 210-2 arranged opposite with respect to the passage axis, corresponding machine axes ZU (displacement parallel to the rotational axis of the milling tool) and BU (displacement perpendicular to the rotational axis) are provided.

The components of the milling units, including the drives thereof, are mounted on the same side of an annular carrier element 220, which is mounted to be rotatable about the passage axis 155 on a bearing element which is fixedly mounted relative to the machine. The rotation is effected by the machine axis X2 , which has a servomotor drive.

The described components of the milling device 200 can jointly be advanced, or moved in translation, parallel to the passage axis 155 by the machine axis P2. To that end, the bearing element for the annular carrier element 220 is mounted on a carriage, which is movable parallel to the passage axis 155, on the upper side of the machine body.

Both milling spindles 210-1, 210-2 are thus movable in a controlled manner in three directions which are alternately orthogonal to one another.

The milling tools 300-1, 300-2 are peripheral milling tools configured as profile milling tools. This means that the active outer contour, or the cutting region, of the profile milling tool equipped with peripheral cutting edges 305 is adapted to the outer contour of the workpiece W to be machined. The cutting region, equipped with peripheral cutting edges, of the profile milling tool does not have a continuously circular-cylindrical enveloping surface, but the diameter of this enveloping surface varies in some portions in the axial direction.

In the example, the workpiece W (insulated rectangular wire) has a rectangular cross-section with rounded edges. The substantially planar upper and lower side faces W1, W2 running parallel to one another are slightly wider than the substantially planar side faces W3, W4 running perpendicular thereto. Radii are formed at each of the transitions between mutually perpendicular side faces so that the longitudinal edges of the workpiece W are rounded.

The profile tool 300-1 has a first portion 310-1 with a cylindrical outer contour, or enveloping surface, and a first diameter, and an adjoining second portion 310-2 which, spaced apart from the first portion, likewise has a cylindrical outer contour, but a smaller diameter. At the transition between the first portion and the second portion there is formed at the start of the second portion an inner radius 312, the profile of which corresponds to the outer radius at the edges of the carrier material T. This is followed at the free end by a sub-portion with a cylindrical outer contour, or enveloping surface. In this sub-portion there is a second diameter which can be, for example, 10% to 20% smaller than the first diameter. The radius of curvature of the inner radius 312 can be, for example, 5% to 15% of the first or second diameter.

If there is a chamfer in the edge region of the carrier material, a profile milling tool having a narrow conical portion instead of a portion with an inner radius can be used.

Thus, two mutually opposite side faces W3, W4 of the carrier material and the radii adjoining them on one side can simultaneously be freed of the insulation layer, or stripped, in a single milling operation. The first portions 310-1 machine the substantially planar side faces W3 and W4, while the transitional region of the inner radius 312, which is likewise provided with peripheral cutting edges and in which the active periphery of the milling tool increases continuously, when seen from the free end, at the same time strips one of the adjoining radii.

The components of the clamping device 400 are mounted on a machine base such that they are fixed relative to the frame. The clamping device 400 has at the end of an oblique arm a carrier plate 405 which carries two clamping units 410-1, 410-2. The distance between the clamping units parallel to the passage axis 155 can be infinitely adjusted. The clamping units are designed in the manner of parallel grippers and each have two clamping jaws which can be moved linearly toward and away from one another and can be advanced symmetrically relative to the passage axis 155. The sides of the clamping jaws facing the workpiece are adapted to the workpiece contour. A separate machine axis is provided to open and close the clamping jaws. The parallel grippers are adjustable to the middle of the wire or to the passage axis 155.

The stripping device is equipped at each of the milling units with components of supporting devices (first supporting device 600-1, second supporting device 600-2), the components of which are configured, overall, to ensure precisely specifiable engagement conditions at the engagement points between the peripheral milling cutters 300-1, 300-2 and the flat material W. It can thus be achieved that the flat material can be stripped completely in the intended portion without damaging the surface of the carrier material T. The construction and function of components of the stripping devices will be explained by way of example in connection with FIGS. 3 and 4A to 4C.

Each of the milling units has at its end on the workpiece side, at which the milling tool is also located, two supporting elements of an associated supporting device. The first supporting device 600-1, which belongs to the first milling unit 210-1, has a first supporting element 610-1A and a second supporting element 610-1B, which are arranged on the same side of the passage axis as the first milling tool 300-1 arranged centrally in the gap between the supporting elements. Each of the supporting elements is configured as a supporting roller 610-1, 610-2 with a substantially cylindrical outer contour and is so mounted at the free end of a rod-like carrier 611 that the supporting roller is able to rotate about a rotational axis running parallel to the rotational axis 217-1 of the milling tool. The rod-like carriers are mounted on the housing of the first milling unit 210-1 so that the supporting elements can be fed in the direction toward the flat material W or in the opposite direction by the feed axis that also moves the first milling unit.

The relative arrangement between the supporting elements 610-1A, 610-1B and the milling tool 300-1 is chosen so that the supporting elements bear against the flat material with their supporting face formed by the outer circumference of the supporting rollers in a region that is in the immediate vicinity of the engagement position between the milling tool and the flat material, when the stripping tool (the milling tool) is in the working position in which it is in engagement with the flat material. The axial distance between the support points of the supporting rollers and the engagement position can be, for example, less than twenty times or less than ten times or less than five times the largest diameter of the flat material. The axial distance can be, for example, between twice and five times or ten times the largest diameter.

Supporting elements 610-2A, 610-2B of a second supporting device 600-2 are mounted in a corresponding manner on the second milling unit 210-2, which supporting elements are in the form of cylindrical supporting rollers and bear in a corresponding manner against the flat material on the opposite side thereof when the second milling unit 210-2 is fed so that the stripping tool (milling tool) is in the working position. In the working position shown, there is thus a pair of supporting rollers immediately in front of and immediately behind the milling tool, which supporting rollers lie against the workpiece at the same axial position and stabilize it between them.

At each milling unit, one of the two supporting elements is fixedly coupled with the associated stripping tool (profile milling cutter) such that the supporting face facing the workpiece can be fixed in an exactly specifiable position, based on the feed direction, relative to the stripping tool. The position is infinitely adjustable by an adjusting device 613. This supporting element (e.g., the first supporting element 610-1A) can thus serve as an adjustable mechanical stop. A corresponding construction is provided on the diametrically opposite side.

In the example of FIGS. 3 and 4A to 4C, the other supporting element of a side, that is to say, for example, the second supporting element 610-1B, is resiliently flexibly mounted so that the position of its supporting face relative to the milling tool, when restoring forces are overcome, is changeable within the scope of a specifiable movement range. In the example of FIG. 4A ﬀ, a compression spring arrangement having at least one compression spring 612 is provided, which compression spring bears on the one hand on a component of the milling unit and on the other hand on the movable bearing for the supporting roller. A corresponding construction is provided on the diametrically opposite side for the second milling unit.

The spring travel, or deflection, of the second supporting element that is structurally possible is infinitely adjustable by an adjustable stop. Thus, the supporting roller, for example, can only deflect according to the projecting length and then likewise absorb forces when the milling cutter is deflected to its maximum depth as shown in FIG. 4B. The second supporting roller can only rebound from the illustrated position according to the representation of FIG. 4C, but cannot deflect further.

A possible process sequence will be explained hereinbelow in connection with FIGS. 4A to 4C. The profile milling tools 300-1, 300-2 are located in a housing 315, visible in FIG. 2, via which dirt particles can be extracted by the suction device.

To be able to specify the removal depth of the profile milling cutters exactly, one of the supporting elements, namely the first supporting roller 610-1A, acts as an infinitely adjustable mechanical stop. To adjust the removal depth, the position of this supporting roller relative to the position of the stripping tool, based on the feed direction (perpendicular to the passage axis), is adjusted so that the active outer radius of the milling tool on the workpiece side has a certain projecting length UB relative to the position of the supporting face of the supporting roller that faces the workpiece. The maximum engagement depth of the stripping tool is given by the projecting length UB. During the adjustment, the stop of the second supporting roller (mounted with limited flexibility) is also adjusted according to the projecting length UB.

To carry out a stripping operation, the flat material W is then positioned in the axial direction, by the draw-in device 140 so that the portion to be stripped lies between the clamping elements 410-1, 410-2 of the clamping device 400. For this positioning operation prior to the stripping operation, the clamping elements are still open (see FIG. 4A). The flat material is then clamped by feeding of the clamping elements on both sides of the portion to be stripped, whereby the free length around the engagement region of the milling tools is reduced.

The milling units are then fed in the direction toward the flat material by the corresponding feed axes. The peripheral faces of the profile milling cutters penetrate the insulation material until the supporting rollers 610-1A, 610-2A serving as fixed stops lie against the flat material on both opposite sides thereof so that the stripping tools cannot penetrate deeper. Because the supporting elements are carried by the milling unit, which also carries the milling tool, joint synchronous feeding of the stripping tools and of the associated supporting elements is automatically achieved. A sensor (not shown), for example, a force sensor notifies the controller when there is contact on both sides and feeding is to be stopped.

FIG. 4B illustrates a situation in which the profile milling tools are in engagement with the insulation layer I. Both the front fixed stop (supporting roller 610-1A) and the rear spring-loaded stop rest on the insulation layer when the milling tool 300-1 located therebetween penetrates the insulation layer. The rear stop is here in contact with its adjustable stop and thus cannot deflect further.

In a following phase of the stripping operation, the entire milling unit is advanced by the P2-axis parallel to the passage axis 155 in the region between the clamping units, while the milling tools rotate about their rotational axes. The insulation layer is thus removed over a specifiable length. FIG. 4C shows a point in time during this stripping operation. The leading fixed stop (first supporting roller 610-1A) continues to roll on the insulation layer I which has not yet been removed. Meanwhile, by contrast, the spring-mounted, trailing second supporting roller 610-1B bears against the exposed surface of the carrier material T since the insulation layer has already been removed there. At the transition from the situation shown in FIG. 4B, in which the trailing supporting roller is still bearing against the insulation layer, to the situation of FIG. 4C, in which the spring-mounted supporting roller is bearing against the carrier material, the supporting roller has passed over the step ST at the transition between the region with insulation layer and the stripped portion, without losing contact with the flat material. On rolling over the step ST, the spring 612 pushes the supporting roller in the direction toward the flat material, without the milling unit as a whole having to be fed. The supporting element that is at the front in the advance direction of the milling units thus always maintains contact with the insulation material I, while the supporting roller that is arranged at the rear is pushed down by the spring arrangement.

In all phases of the stripping operation, each of the milling units is thus in touch contact with the flat material to be stripped by way of the supporting elements arranged in front of and behind the stripping tool. Since the material to be stripped is mechanically contacted on both sides of the engagement position of the stripping tool from both opposite sides by supporting elements in the immediate vicinity of the stripping tools, the position of the flat material in the region of the stripping tools is determined exactly in a mechanical manner.

Furthermore, the supporting elements in front of and behind the engagement position prevent potentially problematic vibrations of the flat material which can occur when support points, or clamping points, are further away from the engagement position.

Once the predefined stripping length has been achieved, the feed axes are activated to retract the profile tools together with the components of the supporting device so that the supporting rollers lose contact with the material. The clamping jaws of the clamping device are then opened again and the wire is advanced by a predetermined length to move the next portion to be stripped into the region between the clamping jaws of the clamping device.

To adapt the components to the machining task in question, on the one hand, the projecting length UB of the fixed stop relative to the profile tool is adjustable. On the other hand, the spring force of the spring arrangement 612 which presses the rear supporting roller against the flat material is also adjustable. The force is preferably adjusted so that, under the given machining parameters, desired vibration damping is achieved. On the other hand, the force is limited to values below a limit value at which permanent deformations in the flat material could occur.

FIGS. 4A to 4C illustrate how mutually parallel side faces of the flat material are stripped at the same time. Because profile tools are used as the stripping tools, the edge regions having radii or chamfers which adjoin those planar side faces on one side are also stripped at the same time.

To also strip the other two side faces (oriented parallel to the plane of the drawing) and the radii which have not yet been stripped, the milling units, by the corresponding feed axes, and the suction system, by the machine axis X2 , are then rotated through 90° about the passage axis 155. The workpiece W remains clamped and thus fixed in its position coaxial with the passage axis 155. The milling tools are then fed horizontally and vertically by the machine axes BO and ZO or BU and ZU, respectively, to the second specified dimension and the faces that have not yet been stripped are stripped by moving the milling device relative to the stationary wire.

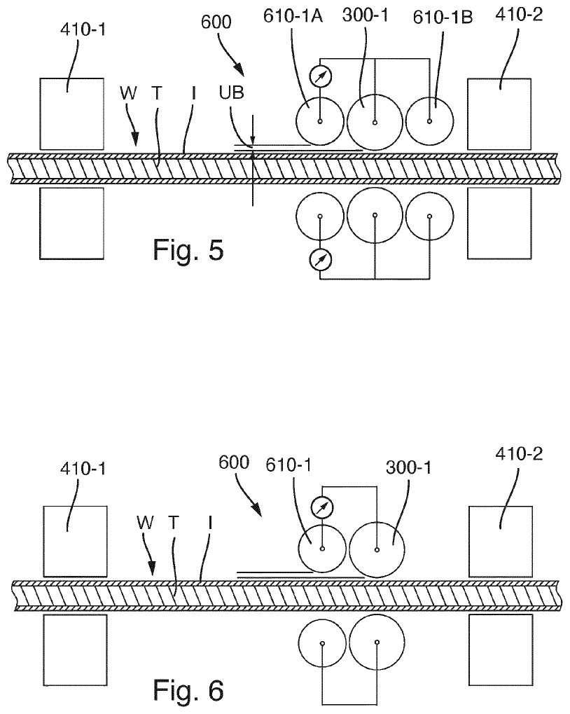

Another example will now be explained with reference to FIG. 5. For reasons of clarity, identical or similar, mutually corresponding components bear the same reference signs as above. Just as in the preceding example, the leading, front supporting roller (first supporting roller 610-1A) is configured as an adjustable fixed stop and thus allows the projecting length UB to be adjusted. The other supporting roller (second supporting roller 610-1B), which trails behind the milling tool when the milling device is advanced, is likewise configured as a fixed stop, that is to say is not spring-mounted. In this example, there is thus no spring re-adjustment, whereby a more simple construction is obtained. The two supporting rollers are generally adjusted to the same extent so that the supporting faces of the supporting rollers lie in a common plane which runs parallel to the passage axis. The active periphery of the stripping tool 300-1 then projects beyond that plane in the direction toward the workpiece by the projecting length UB, wherein the projecting length corresponds approximately to the thickness of the insulation layer I. By this arrangement it can be achieved, inter alia, that, irrespective of the advance direction of the milling unit on stripping, there is always a leading stop which rolls on the insulation material.

Although support on both sides of the stripping tool (that is to say in front of and behind the stripping tool) is generally expedient, it is not essential. FIG. 6 shows by way of example an arrangement in which each stripping tool has only a single associated supporting element 610-1 in the form of a supporting roller. This is configured as an adjustable stop.

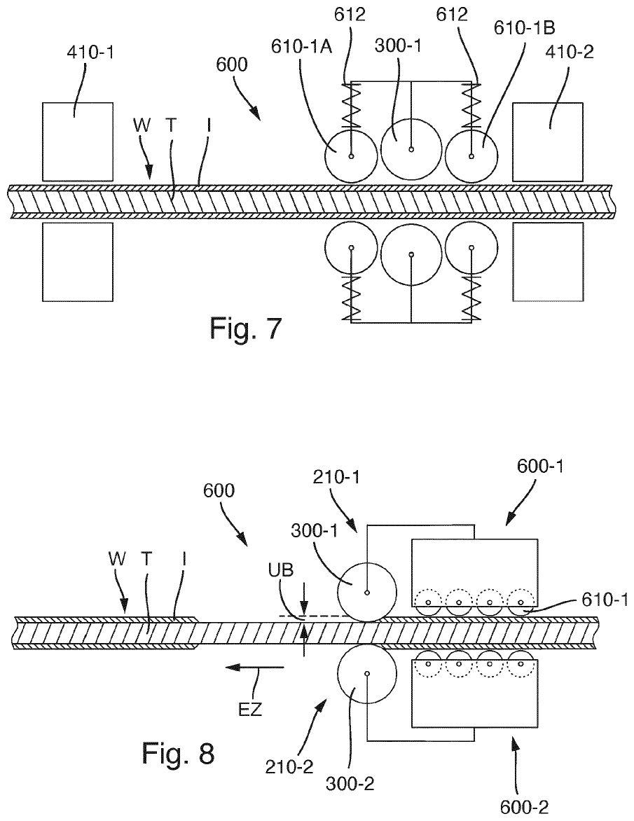

In the example of FIG. 7, the supporting devices of each of the stripping tools (e.g., 300-1) each have two supporting elements configured as supporting rollers 610-1A, 610-1B, of which one is located in front of the stripping tool 300-1 in the advance direction and the other is located behind the stripping tool in the advance direction. Both supporting elements are resiliently flexibly mounted, for example, by way of corresponding spring arrangements 612 so that they are able to bear against the flat material with the build-up of a restoring force. In this example, all the stops are thus mounted by way of springs and fixed to the housing.

Feeding could here be limited, for example, in that the feed force of the feed movement is adjusted with respect to the spring force of the spring arrangements so that the feed movement stops when the supporting rollers lie against the flat material with a certain force (threshold value). Here too, the adjustment of a maximum permissible deflection path by an infinitely adjustable stop is expedient and therefore provided. Owing to the resilient flexible mounting of the supporting rollers, they always reliably lie with a certain pressing force against the flat material W. By this arrangement, desired vibration reduction in the region of the stripping tools can be achieved. Moreover, the solution is relatively simple in terms of construction.

An example will be explained with reference to FIG. 8 that differs from the preceding examples inter alia in that the flat material (the wire W) is not stationary during the stripping operation but, for the purposes of stripping, is advanced along the passage axis 155 in a draw-in direction EZ. In this example, advancement of the wire occurs by way of a draw-in device of the wire processing machine, and a clamping device which clamps the material is not required. The milling units 210-1, 210-2, which are arranged on opposite sides of the passage axis, or of the flat material passing through, are not axially displaceable but are fixedly mounted.

Each of the milling units has a supporting device 600-1, 600-2 designed as a stop unit and has a plurality of supporting rollers 610-1 mounted axially parallel and the outer faces (supporting faces) facing the tool of which lie in a common plane. This supporting device, or stop unit, is mechanically coupled with the associated milling cutter, that is to say the stripping tool 300-1 or 300-2.

The mode of functioning is in principle similar to the example of FIG. 6, where only a single stop element (a single stop roller) is provided per milling cutter. The projecting length UB between the stop elements 610-1, etc. and the milling cutter mechanically coupled therewith can be infinitely adjusted. For the stripping operation, the milling units (consisting of a milling cutter and a stop element or stop unit) are fed synchronously transverse to the wire longitudinal direction in opposite directions until the stop elements of the supporting devices 600-1, 600-2 serving as stop units lie against the insulation layer and the milling cutter thus reaches its maximum penetration depth. The milling units remain in this position, and the wire is moved relative to the milling units by the advance unit in the draw-in direction EZ. When the desired stripped length has been reached, the milling unit is removed from the wire. By corresponding activation, stripping in a continuous process is made possible by the example.

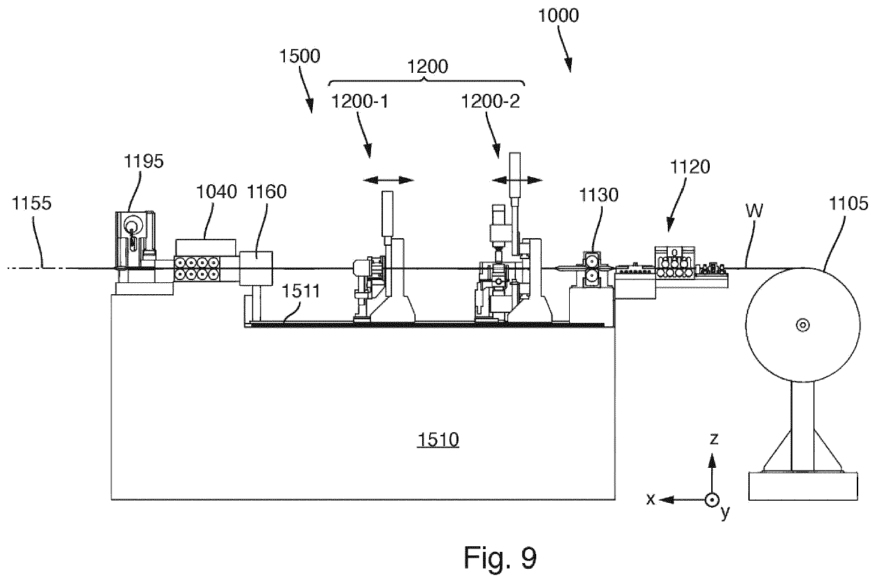

We will explain by way of example below that and how straight shaped parts can also be produced. FIG. 9 shows a side view of a wire processing machine 1000 according to an example that is designed overall as a rod manufacturing machine. The wire processing machine 1000 has an integrated stripping device for stripping portions of the insulated flat material before the aligned, straight shaped part of specifiable length is separated from the supplied flat material.

For reasons of clarity, structurally and/or functionally identical or similar components are denoted by the same reference signs as in the preceding examples, but have been increased by 1000. There are shown: starting material (flat material) W, reel 1105, passage axis 1155, assembly group 1500, which is also referred to as a stripping unit 1500 and has, in this order along the passage axis 1155 of the workpiece, an alignment device 1120, a length measuring device 1130, a milling device 1200, a brushing device 1160 arranged downstream of the milling device, a draw-in device 1140 arranged downstream of the brushing device, and a cutting device 1195 arranged immediately downstream of the draw-in device.

There is no bending shaping of the flat material within the stripping unit 1500 so that the cutting device separates straight shaped parts of specifiable length from the supplied stripped flat material. These shaped parts can then be collected in a collecting device (not shown) and supplied to further processing. Transport to a further downstream processing machine by a suitable conveying device is optionally also provided.

The milling device 1200 is configured to carry out the stripping operation. The milling device 1200 comprises two sub-units arranged axially offset relative to one another, namely a first sub-unit 1200-1 arranged immediately downstream of the length measuring device 1130, and a second sub-unit 1200-2 arranged axially spaced apart behind the first sub-unit. Each of the sub-units is designed to simultaneously strip two mutually opposite side faces of the flat material in one milling operation by peripheral milling.

Each of the sub-units has two milling units, the milling spindles of which are arranged axially parallel and axially offset relative to one another so that the rotational axes of the milling spindles are parallel and offset relative to one another and the milling tools received in the milling spindles can be rotated about rotational axes which are parallel and offset relative to one another (coaxial with the rotational axes of the milling spindles). The milling device 1200 thus has four milling units divided between two sub-units of the milling device.

In the first sub-unit 1200-1, the rotational axes of the two milling units are oriented vertically, that is to say parallel to the z-direction of the machine coordinate system so that the side faces of the flat material that are located opposite one another in a horizontal plane can be stripped at the same time. In the following second sub-unit 1200-2, the rotational axes of the milling units are oriented horizontally, that is to say parallel to the y-axis of the machine coordinate system, to simultaneously strip the upper and lower sides located vertically one above the other of the flat material passing through. The milling units of the sub-units arranged spaced apart one behind the other are thus mounted so that they are offset by 90° relative to one another.

The carrier on which the two milling units of a sub-unit are mounted is mounted not rotatably but so that it is fixed relative to the machine. Furthermore, in some configurations of this example, there is no advance axis for the linear advancement of the sub-units parallel to the passage axis 1155. The sub-units are then each mounted stationarily, and the stripping process takes place as a continuous process in which the milling units, after the feeding of the milling tools, remain immobile, while the flat material is drawn by the draw-in device 1140 in the direction toward the cutting device to strip the flat material along the predefined stripping length.

In the configuration shown, the flat material is stationary during the stripping operation and the sub-units 1200-1, 1200-2 are moved axially to and fro in a coordinated controlled manner. To that end, the base carriers of both sub-units are guided in the manner of carriages on a common linear guide system 1511 arranged on the upper side of the base 1510 and are each movable linearly independently of one another parallel to the passage axis by their own advance drive. To hold the flat material during the stripping operation, a clamping device similar to FIG. 3 can be provided for each sub-unit 1200-1, 1200-2. The clamping devices are movable on a separate linear guide system.

In this example too, the stripping operation is carried out using stripping tools in the form of profile milling tools of the type already described to simultaneously strip not only a planar side face but also an adjoining longitudinal edge having a radius or chamfer. However, unlike in the example above, these various operations do not take place in one and the same plane lying perpendicular to the passage direction but in two planes which are axially offset and spaced apart relative to one another.

On each side of the passage axis there is arranged at least one supporting element, for example, configured as a supporting roller of a supporting device, which supporting element can be fed by the feed axis that feeds the respective stripping tool, synchronously with the feeding of the associated stripping tool, in the direction toward the flat material and is configured to bear with a supporting face against the flat material in the immediate vicinity of the engagement position of the stripping tool when the stripping tool is in the working position. The same principles as in the other examples can be used.

1-17. (canceled)

18. A method of producing straight or bent shaped parts from insulated flat material having an electrically conducting carrier material sheathed by an electrically insulating insulation layer, comprising:
1) drawing the insulated flat material from a material supply by a draw-in device and processing in the wire processing machine to form a straight or bent shaped part of insulated flat material;
2) separating the shaped part from the supplied insulated flat material in a cutting operation, wherein
before the shaped part is separated from the supplied flat material, part of the insulation layer is removed from the electrically conducting carrier material in at least a portion of the insulated flat material in a stripping operation,
stripping tools on opposite side faces of the flat material are fed in the direction toward the side faces to a working position in which the stripping tools are in engagement with the insulation layer, and
the stripping tools and the flat material are moved relative to one another parallel to a passage axis; and
3) synchronously with the feeding of the stripping tools on each side of the flat material, feeding at least one supporting element of a supporting device in the direction toward the flat material and bearing with a supporting face against the flat material in an immediate vicinity of an engagement position of the stripping tool when the stripping tool is in working position.

19. The method as claimed in claim 18, wherein the supporting device has a first and a second supporting element, and the first supporting element bears in front of and the second supporting element bears behind the engagement position of the stripping tool when the stripping tool is in the working position.

20. The method as claimed in claim 18, wherein supporting elements are configured as rotatably mounted supporting rollers and roll on the flat material when the stripping tools and the flat material are moved relative to one another parallel to the passage axis during the stripping operation.

21. The method as claimed in claim 18, wherein one supporting element is fixedly coupled with the associated stripping tool such that a supporting face of the supporting element is fixed or can be fixed in a specifiable position relative to the stripping tool, based on the feed direction, and the supporting element serves as a stop or an adjustable stop, to mechanically limit the feeding of the associated stripping tool.

22. The method as claimed in claim 18, wherein at least one of the supporting elements is resiliently flexibly mounted and bears against the flat material with the build-up of a restoring force when the associated stripping tool is in the working position, and a deflection of the supporting element is mechanically limited.

23. The method as claimed in claim 18, wherein touch contact between the supporting element and the workpiece and/or a pressing force with which a supporting element is pressed against the flat material is recorded by a monitoring system by measurement, and feeding is controlled in dependence on measurement signals from the monitoring system.

24. The method as claimed in claim 18, wherein the stripping operation comprises a milling operation carried out by a milling device, two milling tools have peripheral cutting edges and are rotatable about axially parallel rotational axes, on opposite side faces of the flat material are fed in the direction toward side faces into a working position in which peripheral cutting edges are in engagement with the insulation layer, and the milling tools and the flat material are moved relative to one another parallel to the passage axis.

25. The method as claimed in claim 24, wherein profile milling tools have a first portion with a cylindrical enveloping surface and an adjoining second portion with an axially varying enveloping diameter, and a planar side face and one of the adjoining edges are stripped by a profile milling tool.

26. The method as claimed in claim 18, wherein, before the start of the stripping operation, the flat material is fixed in front of and behind an engagement region of the stripping tools by clamping elements of a clamping device such that it is centered relative to the passage axis, and the supporting elements bear against the flat material in an intermediate region between the clamping elements and the engagement region.

27. A wire processing machine that produces straight or bent shaped parts from insulated flat material, comprising:
a draw-in device that draws the flat material from a material supply and conveys the flat material parallel to a passage axis;
an alignment device that aligns the flat material;
a cutting device that separates the shaped part from the supplied insulated flat material;
an integrated stripping device that strips portions of the insulated flat material before the shaped part is separated from the supplied flat material,
wherein the stripping device has on opposite sides of a passage axis at least one stripping tool that can be fed by a feed axis of the wire processing machine from a neutral position into a working position in which it is in engagement in a material-removing manner with the insulation material,
on each side of the passage axis there is arranged at least one supporting element of a supporting device, which supporting element can be fed in the direction toward the flat material by the feed axis synchronously with feeding of an associated stripping tool and is configured to bear with a supporting face against the flat material in an immediate vicinity of the engagement position of the stripping tool when the stripping tool is in the working position.

28. The wire processing machine as claimed in claim 27, wherein a supporting device associated with a stripping tool has a first supporting element and a second supporting element arranged on different sides of the stripping tool such that the first supporting element can bear in front of and the second supporting element can bear behind the engagement position of the stripping tool when the stripping tool is in the working position.

29. The wire processing machine as claimed in claim 27, wherein supporting elements are configured as rotatably mounted supporting rollers.

30. The wire processing machine as claimed in claim 27, wherein one supporting element is fixedly coupled with the associated stripping tool such that a supporting face of the supporting element, based on the feed direction, is fixed or can be fixed in a specifiable position relative to the stripping tool.

31. The wire processing machine as claimed in claim 27, wherein at least one of the supporting elements is resiliently flexibly mounted, and an adjustable stop that mechanically limits the deflection of the supporting element is provided.

32. The wire processing machine as claimed in claim 27, wherein a monitoring device configured to record by measurement touch contact between a supporting element and the workpiece and/or the pressing force with which a supporting element is pressed against the flat material and control feeding of the associated stripping tool in dependence on measurement signals of the monitoring system.

33. The wire processing machine as claimed in claim 27, wherein the stripping device has a milling device having at least two axially parallel milling units arranged such that two milling tools or profile tools rotatable about axially parallel rotational axes on opposite side faces of the flat material can be fed into a working position in which peripheral cutting edges of the milling tools are in engagement with the insulation layer, and the milling units and the flat material are movable relative to one another parallel to a passage axis of the flat material.

34. The wire processing machine as claimed in claim 27, wherein a controllable clamping device having clamping elements that center the flat material with respect to the passage axis during a stripping operation.
